(19) United States
(12) Patent Application Publication
(10) Pub. No.: US 2007/0180942 A1
(43) Pub. Date: Aug. 9, 2007

(54) Motor vehicle gearbox, in particular with a double clutch

(75) Inventor: Roumen Antonov, Paris (FR)

Correspondence Address: KENYON & KENYON LLP, ONE BROADWAY, NEW YORK, NY, 10004, US

(73) Assignee: ANTONOV AUTOMOTIVE TECHNOLOGIES B.V., Rotterdam (NL)

(21) Appl. No.: 10/593,582

(22) PCT Filed: Mar. 11, 2005
(86) PCT No.: PCT/FR05/00581

§ 371 Date: Sep. 20, 2006

(30) Foreign Application Priority Data
Mar. 24, 2004 (FR) 04 03015

(51) Int. Cl. F16H 3/38

(52) U.S. Cl. 74/340

(57) ABSTRACT

The inventive gearbox device (200) comprises rotary members (1,2,4,5,15) provided with toothed elements (E2, E4-E7, S12, S34, S57-S7, D1-D3, DC, FC, F6, FR, ST), wherein at least one toothed gear (ST, E2, E4) for transmitting motion between two other rotary members (1, 5; 15, 4), thereby producing a gear ratio, can be selectively connected to a rotary member (4; 2) in order to produce another gear ratio.

This invention relates to a motor vehicle gearbox, in particular but not limitatively of the type comprising two rotating input means, for example two input shafts that are coaxial and controlled by a double clutch used to select one or other of the input shafts.

Conventionally, a manually or automatically controlled gearbox comprises a row of gear sets held by two shafts. The gear ratio is defined by whichever of the sets is actuated by means of a coupler, which is typically a synchronizer. With the current trend towards gearboxes with at least six speeds, these gearboxes become heavy and very bulky lengthwise.

Gearboxes comprising two input shafts exist, in particular to obtain successive gear shifts while limiting the drop in the power transmitted. For example, an existing motor vehicle gearbox comprises two input shafts with selection between them via a double clutch and two output shafts each engaging with the two input shafts via several gear sets selectively actuated by couplers mounted on the two output shafts. Such an arrangement requires a distribution device, allowing for the movement to be transmitted to the wheels, whichever output shaft is active, which makes the gearbox considerably heavier. Moreover, one of the input shafts is tubular and surrounds the other input shaft, which has its gears beyond the end of the tubular shaft. This also necessitates the extension of the output shafts, so that the central input shaft can engage with the two output shafts; as a result, the gearbox is extended accordingly, which increases its bulk, its weight and its price. Such a gearbox cannot be installed in a small vehicle.

The aim of the invention is to propose a gearbox that is compact and light relative to the number of gear ratios offered.

Another siim of the invention is to propose a gearbox with reduced axial length.

Yet another aim of the invention is to propose a gearbox with a double clutch that satisfies at least one of the above aims.

An additional aim is to propose a gearbox with a double clutch that is easy to install in a four-wheel drive vehicle.

According to the invention, such a device comprises rotating components holding toothed components, and is characterized in that at least one counter gear of the toothed components, which serves to transmit movement between two rotating components in order to produce a gear ratio, can be selectively coupled with another rotating component in order to produce another gear ratio.

The rotating components can be solid or hollow shafts, housings or any other component capable of holding toothed components. The toothed components can be pinions or ring gears or any other components capable of engaging with each other.

In the scope of this invention, the expression “transmission of movement” signifies that the movement of a first rotating component around a first axis, is transmitted by engagement with the intermediate toothed component, or “counter gear”, rotating around a second axis then transmitted by engagement of the counter gear with another rotating component rotating around a third axis which is generally, but not limitatively, different from the first axis. In other words, the counter gear serves as an intermediary for transmission of movement, to reverse the direction of movement and/or to allow or facilitate a transmission of movement between two rotating components that are for example relatively far from each other.

Such a counter gear can be held by a rotating output component or a rotating input component, to which it is selectively coupled in order to produce a gear ratio.

A counter gear serves to transmit movement for example between a rotating input component and a rotating intermediate component or between two intermediate rotating components or between an intermediate rotating component and an output component. Intermediate rotating component is given to mean a rotating component that is neither a rotating input component nor a rotating output component.

In order to avoid certain difficulties of movement, in its transmission function, provision may be made for the counter gear to be uncoupled from the rotating component that holds it.

In order to produce a reverse gear, a counter gear that has a transmission function for a gear ratio causing a direction of rotation of a rotating output component also has, for another gear ratio, a reverse gear function for the direction of rotation of said rotating output component. This avoids the use of an additional gear having only a reverse gear function.

In particular in order to gain a degree of freedom in the choice of spacing of the successive gear ratios, a counter gear can comprise a cluster gear having two sets of teeth each engaging with teeth connected to one of said rotating components.

Advantageously the counter gear and several other toothed output components are mounted on a rotating output component and each engage with a respective toothed input component mounted on at least one rotating input component and with a respective intermediate toothed component mounted on an intermediate rotating component, coupling means being provided in order to carry out the transmission from at least one rotating input component to the rotating output component, directly or selectively via the counter gear and the intermediate rotating component. Thus, the counter gear allows for one ratio to be produced and the several other toothed output components each allow for two ratios to be produced. The gearbox is considerably shortened.

In order to limit the length of the rotating components, and therefore of the gearbox, two intermediate rotating components can be used. Thus, the at least one counter gear can comprise a second counter gear mounted on a rotating input component between a toothed output component and an intermediate toothed component mounted on a second intermediate rotating component driven by the rotating input component.

At least one of the toothed components that can be selectively coupled with a rotating component in order to produce a gear ratio is a toothed transfer component that can have a proportional transfer function for the gear ratios to a rotating transfer component serving to transmit the movement to at least one axle. Thus a gearbox output gear can be positioned on a shaft that is arranged in a better way in relation to the engine, in particular allowing for easier transmission to two axles for a four-wheel drive transmission. Thus one of the toothed input components that is part of the at least one counter gear can either be coupled to the at least one rotating input component in order to produce a direct ratio between the rotating input component and the rotating transfer component, or uncoupled in order to transmit the movement from the rotating output component to the rotating transfer component.

One of the toothed input components can be part of the at least one counter gear which can either be coupled with the at least one rotating input component in order to produce a direct ratio between the rotating input component and the rotating output component, or be uncoupled in order to transmit the movement between an intermediate rotating component and the rotating output component.

The rotating input component and an intermediate rotating component can be connected by another pair of sets of teeth, engaged with each other and being able to be selectively actuated.

Advantageously, there may be direct engagement between a toothed component on an intermediate rotating component and a toothed component on a rotating output component for a reverse ratio.

Advantageously, in order to limit drops in power during gear changes, the at least one rotating input component can comprise two rotating input components that can be alternatively and selectively coupled to an engine, one of the rotating input components driving the counter gear held by the rotating output component, the other holding toothed input components that define ratios that alternate with those defined by the intermediate toothed components. To the same end, the at least one rotating input component can comprise two rotating input components that can be selectively engaged with the same engine, the shift from one gear ratio to a neighbouring gear ratio comprising an action of engaging at least one of the rotating input components and disengaging the other rotating input component. The rotating input components can be coaxial.

A rotating input component can comprise only one toothed component engaging with a counter gear and/or holding a counter gear.

Advantageously, a device according to the invention can comprise only one rotating output component, in order to limit the complexity of means of transmission of the power at the output of the gearbox.

In a particular embodiment, the device according to the invention can comprise:
two direct ratios each produced by direct engagement of a first input component with a toothed output component,
two first indirect ratios produced by a series of engagements passing through a first counter gear held by the rotating output component,
two second indirect ratios produced by a series of engagements passing through at least a second counter gear held by a rotating input component, and,
a ratio produced by direct engagement between the first rotating input component and the first counter gear coupled with the rotating output component.

It can also comprise an additional ratio produced by direct engagement between a rotating input component and the rotating output component, with the same coupler as the one used to couple the first counter gear with the output component.

It can comprise two toothed components and a double coupler, i.e. allowing for the coupling of one toothed component or neither of the two toothed components, to the at least one rotating input component, to the rotating output component and to each of the two intermediate rotating components. Thus, to produce eight gear ratios, for example seven forward ratios and one reverse ratio, four couplers installed along four axes that are approximately side by side are sufficient. The axial length of such a gearbox is particularly reduced especially considering its large number of ratios.

In a case where the device comprises two concentric input components, one can be designed to engage with the first intermediate rotating component and hold the first two toothed components, the other engaging with the first counter gear and preferably engaging via another pair of sets of teeth with the rotating output component.

Thus, the use of the same toothed component, for example a pinion or a toothed ring gear, to produce several ratios, allows for a reduction in the number of toothed components required to produce all the ratios.

Other characteristics and advantages of the invention will also become apparent from the following description, which relates to non-limitative examples.

In the attached drawings:

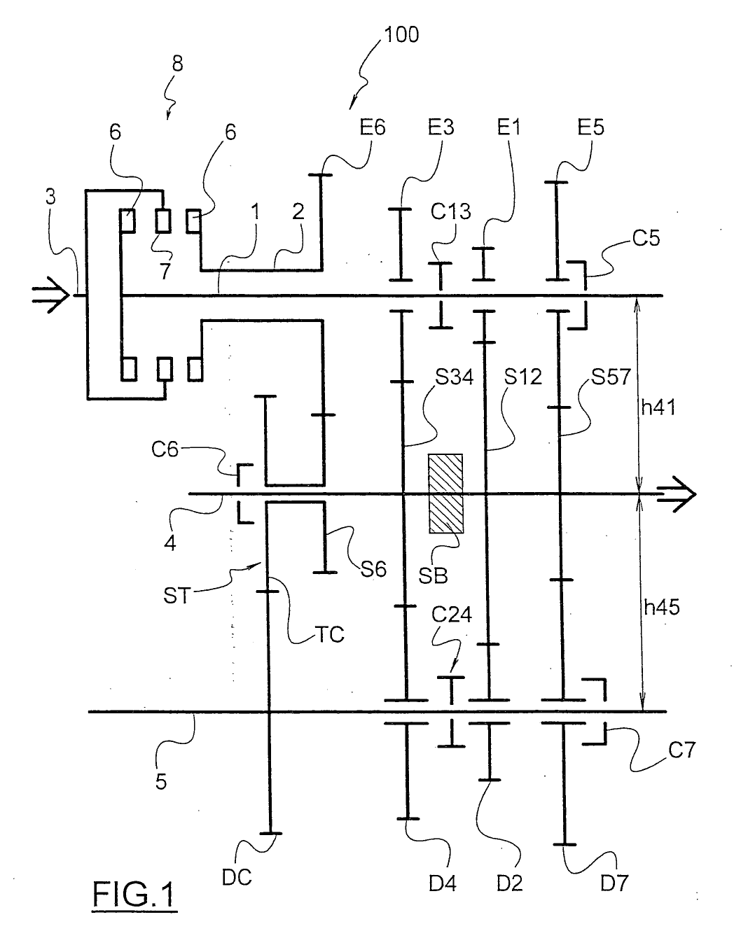

FIG. 1 is a schematic representation of a first embodiment for a gearbox device according to the invention, comprising 7 forward ratios, mounted on an input shaft, an output shaft and an intermediate shaft;

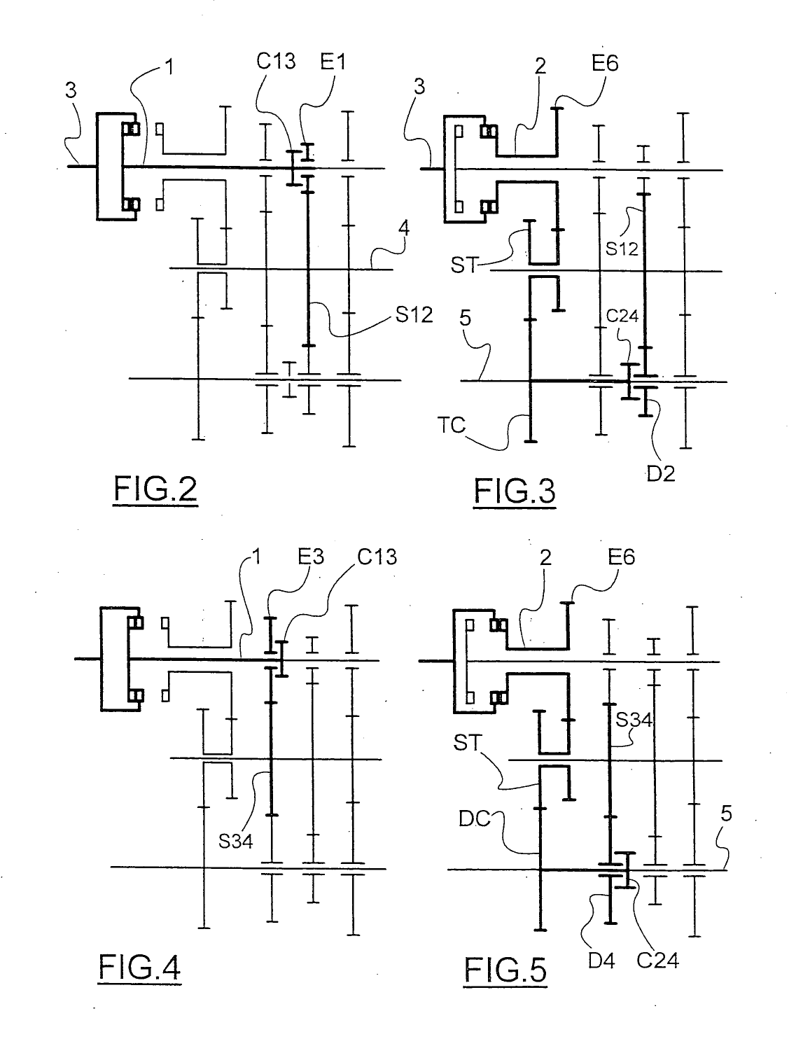

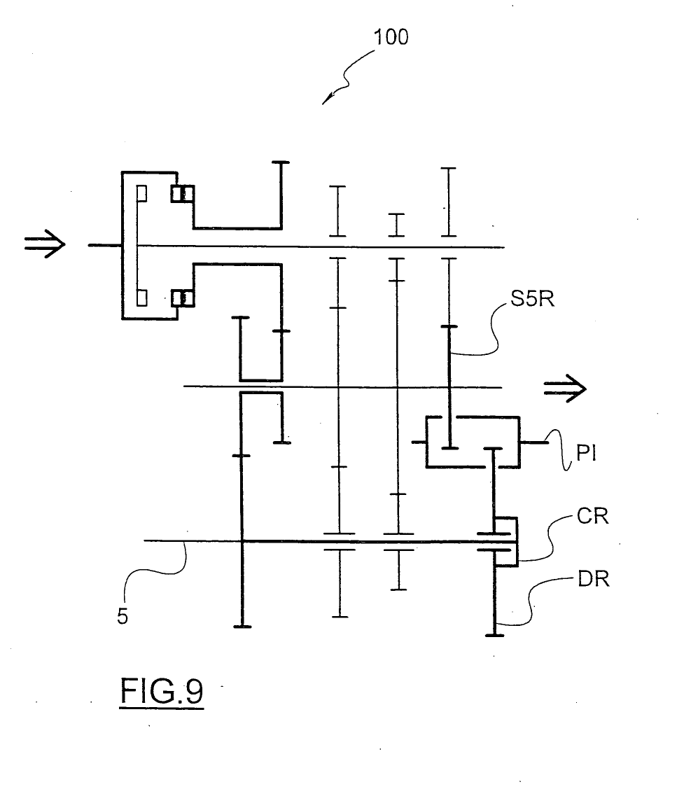

FIGS. 2 to 8 schematically show the operation of the device in FIG. 1, for each of the seven gears;
FIG. 9 is a schematic representation of a second embodiment, in which the seventh forward ratio is replaced by a reverse ratio, in its reverse operating mode;

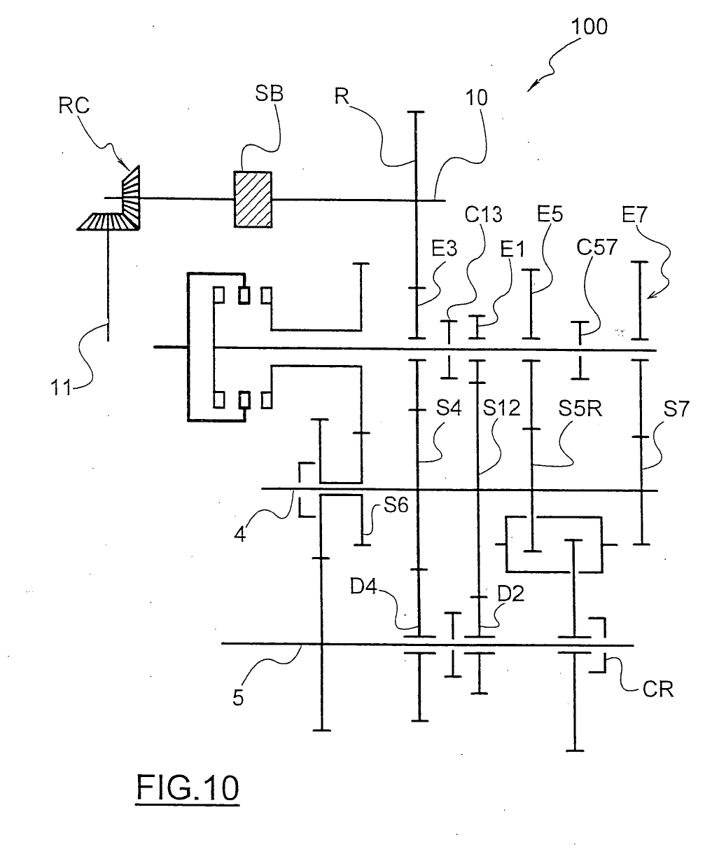

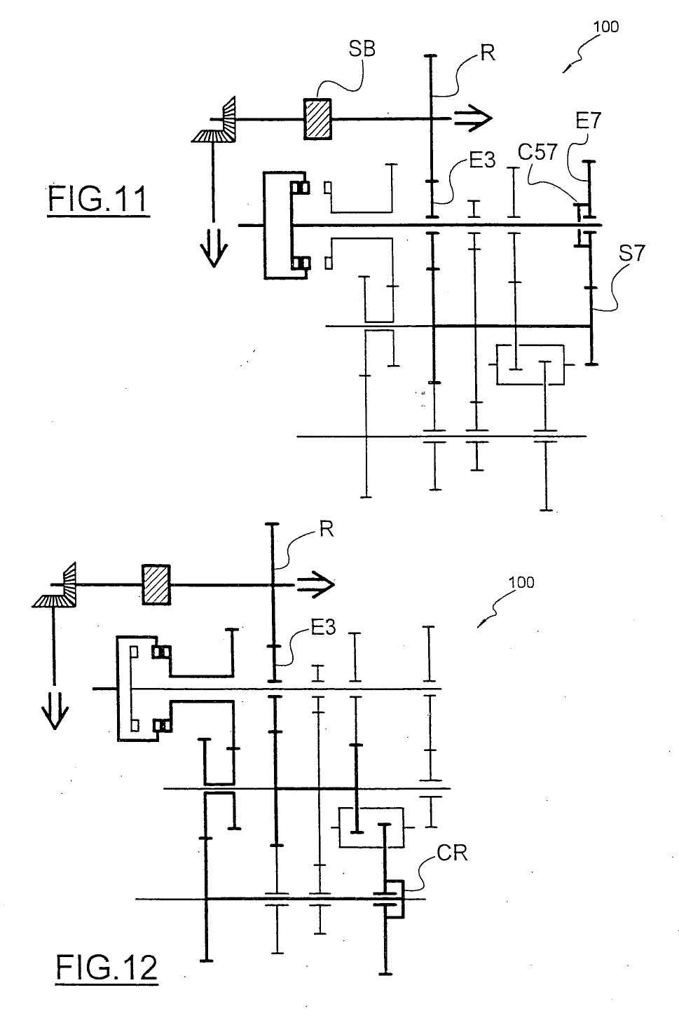

FIG. 10 schematically shows a third embodiment of the gearbox according to the invention, adapted to a four-wheel drive transmission and in which a seventh forward ratio is added to the device in FIG. 9;

FIGS. 11 and 12 illustrate the operation of the device in FIG. 10, in the seventh forward ratio and in the reverse ratio respectively;

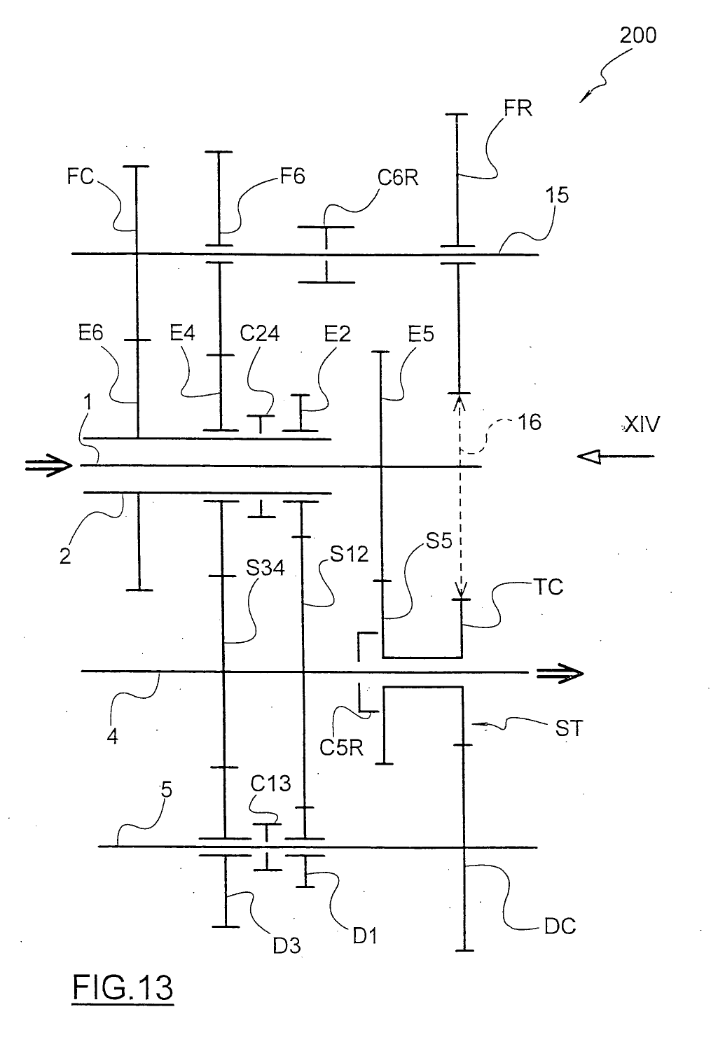

FIG. 13 illustrates another embodiment of the invention, also comprising a second intermediate shaft;

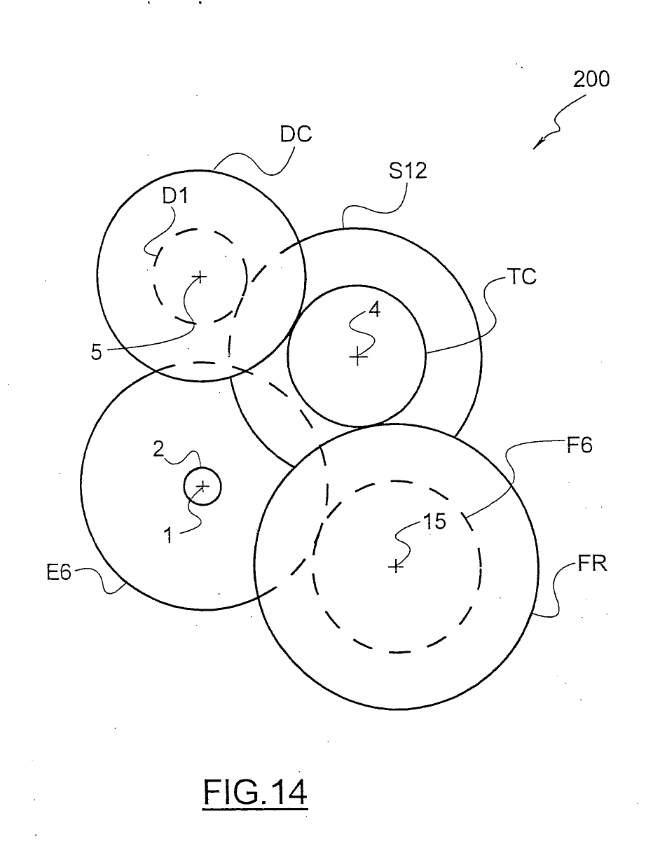

FIG. 14 is a view along XIV of the device in FIG. 13, showing the arrangement of the shafts relative to each other and in particular the engagements to produce a reverse ratio; and,

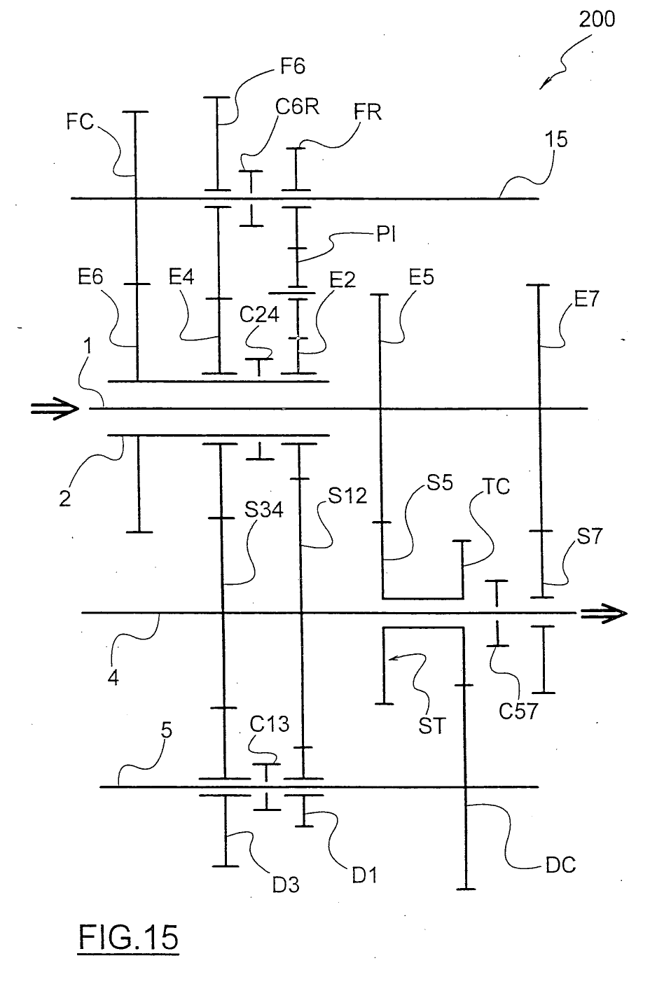

FIG. 15 illustrates a variant of the device in FIG. 13.

FIG. 1 shows a gearbox device 100 comprising two coaxial input shafts, namely a first central shaft 1, and a second tubular shaft 2 mounted rotating freely around the central shaft 1. Each input shaft comprises an input clutch disc 6 to which it is firmly rotatably attached. The discs 6 are mounted opposite one another. A drive shaft 3, coaxial with the input shafts 1, 2, comprises a selection disc 7, mounted between the two input discs 6. The selection disc is mounted coaxially mobile in relation to the input shafts.

Thus, the double clutch 8 comprising the three discs can take three positions, a first position (shown in FIG. 1, as well as in FIG. 10), in which the clutch is disengaged and neither of the discs 6, 7, is in contact with the other, a second position in which the drive shaft 3 is engaged with the first input shaft 1 (illustrated in FIGS. 2, 4 and 6) whilst being disengaged from the second input shaft 2, and a third position in which the drive shaft 3 is engaged with the second input shaft 2 (shown in FIGS. 3, 5, 7, 8, 9, 11 and 12) whilst being disengaged from the first input shaft 1.

The device 100 also comprises an output shaft 4 and an intermediate shaft 5 mounted rotating parallel to the input shafts 1, 2. The output shaft 4 is situated functionally between the input shafts 1, 2 on the one hand and the intermediate shaft 5 on the other hand.

The four shafts 1, 2, 4, 5 rotate in positions that are fixed in relation to each other in a housing, not shown. The output shaft 4 has, in relation to the input shafts 1, 2 a centre distance (i.e. the distance between the two shafts axis) h41 that is smaller than its centre distance h45 from the intermediate shaft 5. In the figures, the shafts are shown as coplanar for the sake of clarity. However, in order to limit the bulk of such a gearbox and adapt it to the available space, the actual arrangement can be “folded” along the axis of the output shaft 4.

In the following, the side of the gearbox on which the clutch 8 is located, therefore the left-hand side in the representation chosen for the figures, will be called “proximal”, and the opposite side, therefore the right-hand side, will be called “distal”.

The output shaft 4 holds, in order from the proximal to the distal side:
a common transfer gear TC that engages with a common intermediate gear DC attached to the intermediate shaft 5;
a sixth ratio output gear S6 engaging with a sixth ratio input gear E6 attached to the tubular input shaft 2;
a third and fourth ratio output gear S34 engaging with a third ratio input gear E3 held by the central input shaft 1 beyond the distal end of the tubular input shaft 2, and with a fourth ratio intermediate gear D4 held by the intermediate shaft 5;
a first and second ratio output gear S12 engaging with a first ratio input gear El held by the central input shaft 1 beyond the distal end of the tubular input shaft 2, and with a second ratio intermediate gear D2 held by the intermediate shaft 5;
a fifth and seventh ratio output gear S57 engaging with a fifth ratio input gear E5 held by the central input shaft 1 beyond the distal end of the tubular input shaft 2, and with a seventh ratio intermediate gear D7 held by the intermediate shaft 5;

The common transfer gear TC and the sixth output gear S6 are attached to one another, have a different number of teeth and diameter, and together form a cluster gear ST that is selectively free to rotate on the output shaft 4 or coupled to it via a coupler C6, for example a synchronizer or a jaw clutch, mounted on the output shaft 4 on the proximal side of the cluster gear. It would have been possible to use a single gear such as S6 engaging both with an input gear such as E6 and with the common intermediate gear DC, but the use of a cluster gear allows for the spacing of the ratios of the gearbox to be chosen freely. Alternatively, any one of the output gears S34, S12, S57 could have been replaced with a cluster gear.

With the current solution, the first six ratios are chosen freely, and there is a certain dependence between the fifth and the seventh ratio but it is acceptable because the sixth ratio is positioned as desired between fifth and seventh.

The seven ratios can be rendered totally independent by using two cluster gears on the output shaft instead of only one.

The third ratio input gear E3 and the first ratio input gear E1 are selectively either both free to rotate, independently of each other, on the input shaft 1, or one is coupled with the input shaft 1 and the other is uncoupled from the input shaft 1 by a double coupler C13 mounted between them on the input shaft 1.

The fourth ratio intermediate gears D4 and second ratio intermediate gears D2 are selectively either both free to rotate, independently of each other, on the intermediate shaft 5, or one is coupled to the intermediate shaft 5 and the other is uncoupled from the intermediate shaft 5 by a double coupler C24 mounted between them on the intermediate shaft 5.

The output gears S34, S12 and S57 are attached rotatably to the output shaft 4.

The input gear E5 is selectively free to rotate on the central input shaft 1 or coupled with the latter by a coupler C5 mounted on the central input shaft 1 on the distal side of the gear E5.

The intermediate gear D7 is selectively free to rotate on the intermediate shaft 5 or coupled with the latter by a coupler C7 mounted on the intermediate shaft 5 on the distal side of the gear D7.

A gearbox output SB with helical teeth, attached to the output shaft 4, is mounted between the output gears S34 and S12 in order to drive, at least indirectly, the input of a differential (not shown) itself driving wheel shafts, not shown.

In FIGS. 2 to 8, illustrating the operation of the device in FIG. 1 for each of the ratios, the couplers are shown only when they are in a state of coupling and transmitting power. In these Figures, the components participating in the production of the ratio concerned are shown in thick lines.

As illustrated in FIG. 2, in order to produce the first ratio, the first ratio input gear E1 is coupled with the first input shaft 1 by means of the coupler C13 and the drive shaft 3 is engaged with the first input shaft 1. The first ratio input gear therefore drives the first and second ratio output gear S12 and therefore the output shaft 4 on which the latter is fixed. The couplers C5, C6 are in an uncoupled position. The coupler C24 can be placed in the coupling position of the intermediate gear D2.

When this is done, the second ratio is effectively produced, by reversing the input clutch 8 in order to engage the drive shaft 3 with the second input shaft 2. The cluster transfer gear ST, which rotates freely around the output shaft 4, transmits the movement of the input shaft 2 to the intermediate shaft 5. The second ratio intermediate gear D2 therefore drives the first and second ratio output gear S12 and therefore the output shaft 4 on which the latter gear is fixed. The coupler C13 can be left in the coupling position of the gear E1 so that the gearbox is ready to shift back into first gear, or placed in coupling position of the input gear E3 in order to prepare for the shift into third gear.

In this latter case, as illustrated in FIG. 4, the third ratio is effectively produced by simply reversing once again the clutch 8 in order to engage the drive shaft 3 with the first input shaft 1. The third ratio input gear E3 therefore drives the third ratio output gear S3 and therefore the output shaft 4 on which the latter gear is fixed. During this time, the coupler C24 can be left in the coupling position of the gear D2 in order to prepare the gearbox to shift back into second gear by a simple reversal of the clutch 8, or the coupler C24 can be shifted to the coupling position of the intermediate gear D4.

In this latter case, as illustrated in FIG. 5, in order to effectively produce the fourth ratio, the clutch 8 is once again reversed in order to engage the drive shaft′3 with the second input shaft 2. The cluster counter gear ST, which rotates freely around the output shaft 4, transmits the rotational movement of the second input shaft 2 to the intermediate shaft 5 by means of the common intermediate gear DC, which is fixed to the intermediate shaft 5. This movement is transmitted with an appropriate speed ratio to the third and fourth ratio output gear S34 by means of the fourth ratio intermediate gear D4, coupled with the intermediate shaft 5. During this time, the coupler C13 can be left in the coupling position of the input gear E3 in preparation for a return to operation in third gear by reversal of the clutch 8, or the coupler C13 can be placed in the neutral position, i.e. the uncoupling position of the gears E1 and E3, and the coupler C5 can be placed in the coupling position of the input gear E5.

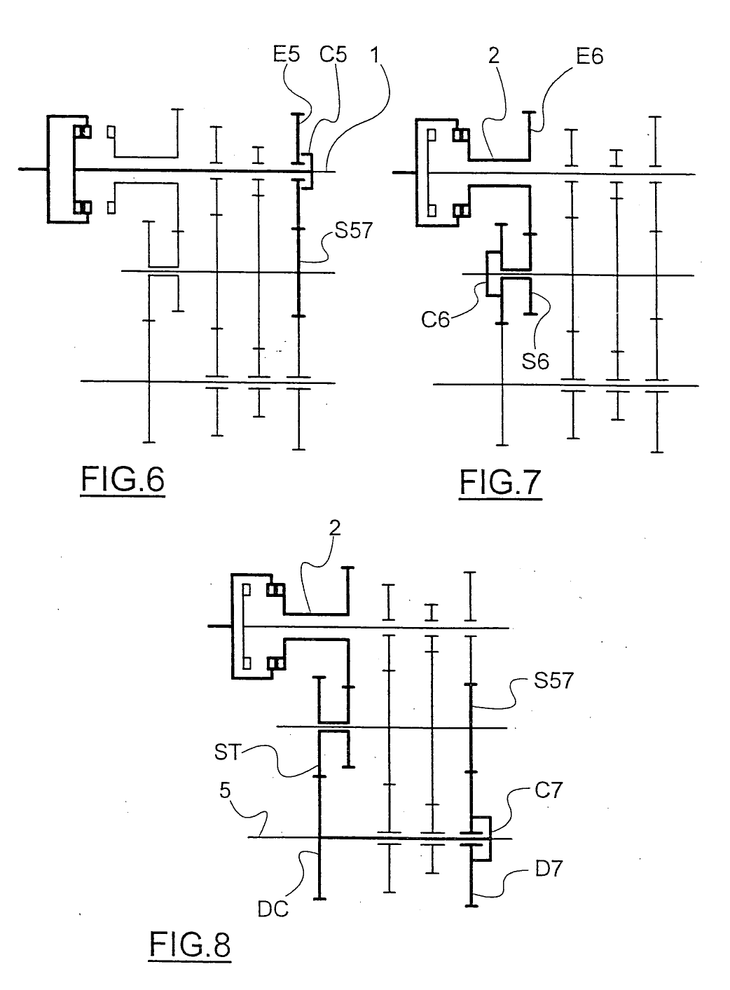

In the latter case, as illustrated in FIG. 6, the fifth ratio is then produced, by simply reversing the clutch 8 in order to engage the drive shaft 3 with the first input shaft 1. The fifth ratio input gear E5, attached to the first input shaft 1, therefore drives the fifth and seventh ratio output gear S57 and therefore the output shaft 4 to which it is attached. During this time, the coupler C24 can be left in the coupling position of the intermediate gear D4 in preparation for a return to operation in fourth gear by reversal of the clutch 8, or the coupler C24 can be placed in the neutral position, and the coupler C6 in the coupling position of the counter gear ST with the output shaft 4.

In the latter case, as illustrated in FIG. 7, the sixth ratio is then produced, by reversing the clutch 8 in order to engage the drive shaft 3 with the second input shaft 2. The sixth ratio input gear E6, fixed to the second input shaft 2, therefore drives the sixth ratio output gear S6 and therefore the output shaft 4 with which the latter ratio is coupled. During this time, the coupler C5 can be left in the coupling position of the input gear E5 with the input shaft 1, in preparation for a return to operation in fifth gear by reversal of the clutch 8, or the coupler C5 can be placed in the uncoupling position.

In the latter case, as illustrated in FIG. 8, the seventh ratio is effectively produced, by placing the clutch 8 in the neutral position, by placing the coupler C6 in the uncoupling position and the coupler C7 in the coupling position, and then by engaging the drive shaft 3 with the second input shaft 2. The sixth ratio input gear E6, fixed to the second input shaft 2, therefore drives the counter gear ST which transmits a rotational movement of the second input shaft 2 to the intermediate shaft 5 by means of the common intermediate gear DC, which is fixed to the intermediate shaft 5 and engages with the counter gear ST. This movement is transmitted to the fifth and seventh ratio output gear S57 by means of the seventh ratio intermediate gear D7, coupled with the intermediate shaft 5.

Thus, the counter gear ST has the double function of producing one of the ratios (sixth in the example) by direct engagement between the input and the output, and of transmitting the movement of the second input shaft 2 to the intermediate shaft 5, which holds the intermediate gears, which are in fact “relocated” input gears. The axial length of the gearbox is greatly reduced given its number of ratios. The number of gears is also reduced because three output gears S12, S34, S57 are active for two different ratios. Four ratios out of seven are produced by a single engagement, and the three others by three successive engagements, which makes an average considerably lower than 2, which is remarkable for a double-clutch gearbox and would even be excellent for a conventional single-clutch gearbox.

As the two input shafts remain independent, the device comprises, as has been seen, six successive gear ratios, from first to sixth, of which one ratio is always produced by engaging a different input shaft from the shaft used to produce an immediately neighbouring gear ratio. Thus, when shifting to the gear above it is possible to prepare the second ratio while using the first ratio, to prepare the third ratio while using the second ratio, to prepare the fourth ratio while using the third ratio, to prepare the fifth ratio while using the fourth ratio and to prepare the sixth ratio while using the fifth ratio. It is thus sufficient to switch the clutch 8 from one of its engagement positions to the other in order to move up from one ratio to the one immediately above. This allows for a fast, smooth gear shift for these ratios with an imperceptible drop in power. The same is true for a gear shift downwards. The prepared but not activated ratio rotates the input shaft 1 or 2, which is disengaged, at a different speed from that of the engine 3, but this is not a drawback.

In the embodiment illustrated in FIG. 9, the seventh forward ratio has been replaced with a reverse ratio. To this end, the seventh ratio intermediate gear D7 has been removed and replaced with an intermediate reverse gear DR. In the example illustrated, so that this intermediate reverse gear DR has a sufficient diameter it is offset in relation to the fifth and reverse output gear S5R. A reverse idler gear PI continuously engages with the intermediate reverse gear and with the fifth and reverse ratio output gear.

As in the case in FIG. 8, the intermediate shaft 5 is driven by engaging the counter gear ST with the sixth ratio input gear and with the common intermediate gear DC. The intermediate reverse gear DR being coupled with the intermediate shaft 5 by the coupler CR, it drives, via the reverse idler gear PI, the fifth and reverse ratio output gear S5R.

In the embodiment illustrated in FIG. 10, described in terms of its differences relative to the embodiment in FIG. 9, a seventh forward ratio has been added, the reverse ratio being reserved. To this end, a seventh ratio input gear E7 has been added rotating freely on the first input shaft 1, on the distal side, and a seventh ratio output gear S7 fixed rotatably on the output shaft 4 continuously engages with the input gear E7. The coupler C5 has become a double coupler C57 adapted to be able to independently couple one or the other or neither of the fifth and seventh ratio input gears E5, E7.

No matter which gear ratio is effectively established, the neighbouring ratio or, when applicable, any one of the two neighbouring ratios, can be prepared concurrently, after which the gear shift is carried out by reversal of the clutch 8. This is true even for the first-reverse range.

Moreover, the gearbox output gear SB is no longer mounted rotatably fixed on the output shaft 4, but on a transfer shaft 10. A transfer gear R mounted fixed on the transfer shaft continually engages with the third ratio input gear E3. Thus, the transfer gear introduces a coefficient to the speed of rotation of the output shaft 4.

The third ratio is produced by directly engaging the transfer gear R with the input gear E3 attached to the first input shaft 1 by the coupler C13, without the power passing through the output shaft 4. The other ratios are produced as described previously, except that the movement of the output shaft 4 is transmitted to the transfer shaft 10 via the third ratio input gear E3 which, in the uncoupled state of the input shaft, constitutes a counter gear according to the invention between the output shaft 4 and the transfer shaft 10. The output gear S4 is only an output gear, in the sense used thus far, for the fourth ratio. For the ratios other than third and fourth gear, it acts as a power transfer gear to the transfer shaft 10 via the gear E3 forming a counter gear.

For use dn a vehicle with two driving axles, the engine, and therefore the transfer shaft, being transverse, the transfer shaft 10 also comprises a bevel gear RC allowing for the driving of a longitudinal transmission shaft 11.

In practice it is advantageous that the transfer shaft 10 is underneath the input shafts 1 and 2, and the shafts 4 and 5 are above the input shafts 1 and 2. In other words, FIG. 10 is rotated 180° C. in its own plane.

The transfer shaft 10 is then relatively low in the vehicle, which is particularly suited to a four-wheel drive transmission, in particular because the drive shafts are generally arranged lower than the engine.

Moreover, this allows for the gearbox output gear SB to be positioned more freely in relation to the gearbox device than when this gear is held by a shaft, such as the shaft 4, situated at the centre of the gearbox. Furthermore, the helical teeth of the gearbox output gear SB generate substantial axial stresses on the shaft that holds them, especially since this gear generally has a small diameter. Provision can thus be made for a transfer shaft 10 and bearings for this shaft, that are more suitable than when the gearbox output gear is mounted directly on the gearbox output shaft.

As an example, for the embodiments in FIGS. 1-12, the gears have the following diameters, in millimeters:

E6: 117

E3: 81

E1: 45

E5: 107

S6: 84

TC: 101

S4 or S34: 120

S12: 156

S5R or S57: 94

DC: 119

D4: 64

D7: 126

DR: 130

E7: 123

S7: 78

The ratios thus obtained are as follows:

| | |
|---|---|
| first ratio | 3.47 |
| second ratio | 2.08 |
| third ratio | 1.48 |
| fourth ratio | 1.02 |
| fifth ratio | 0.88 |
| sixth ratio | 0.72 |
| seventh ratio | 0.63 |
| reverse ratio | 2.95 |

In the gearbox 200 in FIG. 13, which will be described in terms of its differences to the gearbox in FIG. 5, the roles of the first and the second input shaft are reversed. More particularly, the counter gear ST is now mounted at the distal end of the output shaft 4 and its fifth ratio output gear S5 engages with an input gear E5 that is rigidly fixed to the first input shaft 1 beyond the distal end of the tubular shaft 2.

The intermediate shaft 5 is therefore now driven by the first input shaft 1 and no longer by the second input shaft 2, still via the counter gear ST mounted on the output shaft 4.

The output gears S12 and S34 now situated on the proximal side of the counter gear ST, engage respectively with intermediate gears Dl and D3 mounted rotating freely on the intermediate shaft 5, on either side of a coupler C13 that allows for one or the other or neither of them to be coupled with the shaft 5. The gears S12 and S34 also engage, respectively, with input gears E2 and E4 that are mounted rotating freely on the second input shaft 2 (and no longer on the first shaft 1) on either side of the coupler C24 that allows for one or the other, or neither of them, to be coupled with the shaft 2.

The sixth ratio input gear E6, fixed to the shaft 2 on the proximal side in relation to E2 and E4, drives a second intermediate shaft 15 by engaging with a common gear FC attached to the shaft 15. The coaxial input shafts 1 and 2 are therefore mounted functionally between the output shaft 4 and the second intermediate shaft 15.

A sixth ratio intermediate gear F6 and an intermediate reverse gear FR are mounted rotating freely on the second intermediate shaft 15 on either side of a double coupler C6R which allows for one or the other or neither of F6 and FR to be coupled with the shaft 15.

The gear F6 engages with the fourth ratio input gear E4.

As indicated by a dotted arrow 16, the intermediate reverse gear FR directly engages with the common transfer gear TC by by-passing the line of the input shafts 1 and 2. This is possible because the embodiment shown in flat form is in fact “folded” along the axis of the input shafts (see FIG. 14).

The engagement of each of the first five ratios is obtained by methods similar to those described for the 2^{nd}, 1^{st}, 4^{th}, 3^{rd} and 6^{th} ratios respectively, in FIG. 1, except that the role of the two input shafts 1 and 2 is reversed.

For the sixth ratio, the coupler C24 being in the neutral position and the coupler C6R coupling the sixth ratio intermediate gear F6 with the shaft 15, the power is transmitted from the second input shaft 2 to the output shaft 4 by the engagements E6-F6 and F6-E4-S24. The input gear E4 uncoupled from the input shaft 2 acts as a counter gear between the second intermediate shaft 15 and the output shaft 4. During this time, the coupler C5R can couple the output gear S5, i.e. the counter gear ST with the output shaft 4 ih order to prepare for a return to operation in fifth ratio by simple reversal of the double input clutch, not shown.

For operation in reverse, the coupler C6R connects the intermediate reverse gear FR with the second intermediate shaft 15, the coupler C5R releases the common transfer gear TC, i.e. the counter gear ST, from the output shaft 4 and the coupler C13 connects the gear D1 with the intermediate shaft 5.

FIG. 14 is a view in a plane perpendicular to the shafts. As illustrated, the projections of the shafts in the plane in FIG. 14 form a quadrilateral. Thus the gearbox is compact.

FIG. 14 also illustrates the successive engagements of the gears E6 and FC, FR and TC, TC and DC, Dl and S12 necessary for producing the reverse gear ratio.

As an example, for the embodiment in FIGS. 13-14, the gears have the following diameters, in millimetres:

E6: 118

E4: 104

E2: 70

E5: 112

FC: 86

F6: 100

FR: 140

S34: 100

S12: 134

S5: 92

TC: 74

DC: 102

D1: 42

D3: 76

The ratios thus obtained are as follows:

| | |
|---|---|
| first ratio | 3.61 |
| second ratio | 1.91 |
| third ratio | 1.49 |
| fourth ratio | 0.96 |
| fifth ratio | 0.82 |
| sixth ratio | 0.73 |
| reverse ratio | 1.69 |

In the embodiment in FIG. 15, which will be described only in terms of its differences relative to the embodiment in FIG. 13, the intermediate reverse gear FR engages with a reverse idler gear PI mounted idle on an additional shaft, this reverse idler gear itself engaging with the second ratio input gear E2. Thus, the first and second ratio output gear S12 acts as an output gear for the reverse ratio.

As an example, for the embodiment in FIG. 15, the reverse ratio intermediate gear FR has a diameter of 42 millimeters and the reverse ratio thus obtained is 2.33. Because of this arrangement, the gear with the greatest diameter is reduced to 134 millimeters for the first and second ratio output gear S12. The compactness of the gearbox is further increased because of this.

The device in FIG. 15 also comprises a seventh gear ratio produced by a seventh ratio input gear E7 mounted fixed to the first input shaft 1 and engaging with a seventh ratio output gear S7 that can be selectively coupled with the output shaft 4, using the same coupler C57 as the fifth ratio output gear S5, i.e. the counter gear ST.

This embodiment is particularly advantageous because it produces eight ratios (seven forwards ratios+reverse) with just four double couplers, only one of which is in the coupling position for each ratio, which simplifies the controls, and for each ratio it is possible to prepare concurrently the neighbouring ratio or, depending on the case, any one of the two rleighbduring ratios, in order to then carry out the gear shift by simple reversal of the double input clutch, not shown. The four couplers are mounted on four different axes, so that the axial bulk of the couplers is not added to in any way. Of the seven forward ratios, four involve just one engagement under load, the other three each involve three engagements, the average of the number of engagements under load therefore only being approximately 1.85, with the added advantage that the seventh ratio only involves one.

In this embodiment, the second ratio input gear E2 itself also acts as a counter gear when it is uncoupled, for operation in reverse.

The gearbox output gear, not shown, can be attached to the output shaft 4.

Of course, the invention is not limited to the examples that have just been described and numerous adjustments can be made to these examples without going beyond the scope of the invention.

In the embodiment in FIGS. 10-12, instead of with the third ratio input gear, it is also possible to engage the transfer gear with another of the gears of those E1, E2, E4 mounted rotating freely on the input shafts 1, 2, and the intermediate shaft 5, and engaging with one of the gears mounted fixed on the output shaft 4. It is also possible to engage it with one of the gears S1, S3 mounted fixed on the output shaft 4.

In the example in FIGS. 1 to 8, the centre distance h41 could be larger than the centre distance h45, so that the input gears are, from proximal to distal, a seventh ratio gear attached to the shaft 2 and three fourth, second and sixth ratio gears mounted on the shaft 1. The intermediate shaft thus contains, from proximal to distal starting from the gear DC: third, first and fifth ratio gears. With this arrangement, all of the shifts, including between the sixth and seventh ratio, can be prepared by positioning the couplers concurrently and then effectively establishing the new ratio by simple reversal of the clutch 8.

In all of the embodiments, the two input shafts 1, 2 can be replaced with a single shaft, and the double clutch 8 with a conventional clutch that selectively engages or disengages the single input shaft in relation to the drive shaft 3. In this case, only the coupler or couplers necessary for establishing the effective gear ratio is/are in the coupling position. In order to change the ratio, the input clutch is disengaged, the position of the couplers is changed, and then the input clutch is re-engaged.

In the example in FIG. 10, an eighth ratio could be produced by placing an eighth ratio intermediate gear rotating freely at the distal end of the intermediate shaft 5 and engaging with the gear S7, and by replacing the coupler CR with a double coupler.

The gearboxes according to the invention can be automated. A controller controls, through a predetermined logic, with or without the possibility of the intervention of the driver of the vehicle, the actuation of the couplers and the input clutch, and prevents or delays the execution of any dangerous commands from the driver, such as for example shifting into reverse when the vehicle is moving forwards, or the engagement of inappropriate gears that are dangerous for the engine and/or the gearbox and/or the control of the trajectory of the vehicle or its braking.

In the example in FIG. 10, the relative improvement at the transferred output is independent of the other improvements described in FIGS. 9 and 10.

Still in the example in FIG. 10, the input gears E5 and E7 can be attached to the central input shaft 1, and a double coupler can be placed between the output gears S5R and S7 in order to selectively couple one or neither of the two to the output shaft 4. However, the coupler must then transmit the high reverse torque.

The examples in FIGS. 13 to 15 can be arranged so as to transfer the gearbox output gear such as BS to a transfer shaft such as 10 installed for example behind the plane in FIGS. 13 and 15.

1. Gearbox device (100, 200) comprising rotating components (1, 2, 4, 5, 15) holding toothed components (E1-E7, S12, S34, S5, S57, S6, S7, D1-D4, D7, FR, ST, SB), characterized in that at least one counter gear (ST, E2, E3, E4) of the toothed components, which serves to transmit movement between two rotating components in order to produce a gear ratio, can be selectively coupled with another rotating component in order to produce another gear ratio.

2. Device according to claim 1, characterized in that the counter gear (ST) is held by a rotating output component (4) to which it can be coupled in order to produce said other gear ratio.

3. Device according to claim 1, characterized in that the counter gear (E2, E3, E4) is held by a rotating input component to which it can be coupled in order to produce said other gear ratio.

4. Device according to claim 1, characterized in that at least one counter gear (ST) serves to transmit the movement between a rotating input component (1, 2) and an intermediate rotating component (5).

5. Device according to claim 1, characterized in that at least one counter gear (E2, E4) serves to transmit the movement between an intermediate rotating component (15) and a rotating output component (4).

6. Device according to claim 1, characterized in that, in its transmission function, the counter gear is uncoupled from the rotating component that holds it.

7. Device according to claim 1, characterized in that at least one counter gear (ST), which for one gear ratio causes a direction of rotation of a rotating output component (4), also has, for another gear ratio, a reverse gear function for the direction of rotation of said rotating output component.

8. Device according to claim 1, characterized in that the at least one counter gear comprises a cluster gear (ST) having two sets of teeth (S5, TC) each engagement with a set of teeth connected to one of said rotating components between which it transmits the movement.

9. Device according to claim 1, characterized in that the counter gear (ST) and several other toothed output components (S12-S34) are mounted on a rotating output component (4) and each engage with a respective toothed input component (E1-E4) mounted on at least one rotating input component (1, 2), and with a respective intermediate toothed component (DC, D1-D4) mounted on an intermediate rotating component (5), coupling means (C13, C6, C24) being provided in order to carry out the transmission from the at least one rotating input component (1, 2) to the rotating output component (4), directly or selectively via the counter gear (ST) and the intermediate rotating component (5).

10. Device according to claim 1, characterized in that at least one of the toothed components (E3) that can be selectively coupled with another rotating component (1) in order to produce a gear ratio is a transfer component that has a proportional transfer function for the gear ratios to a rotating transfer component (10) serving to transmit the movement to at least one wheel shaft.

11. Device according to claim 10, characterized in that one of the toothed input components (E3) belongs to the at least one counter gear and can either be coupled with the at least one rotating input component in order to produce a direct ratio between the rotating input component (1) and the rotating transfer component (10), or be uncoupled in order to transmit the movement of the rotating output component (4) to the rotating transfer component (10).

12. Device according to claim 5, characterized in that one of the toothed input components (E2, E4) belongs to the at least one counter gear and can either be coupled with the at least one rotating input component (2) in order to produce a direct ratio between the rotating input component (2) and the rotating output component (4), or be uncoupled in order to transmit the movement between an intermediate rotating component (15) and the rotating output component (4).

13. Device according to claim 12, characterized in that the rotating input component (1) and the rotating intermediate component (15) are connected by another pair of sets of teeth (E6-FC), engaged with each other.

14. Device according to claim 12, characterized in that there is direct engagement between a toothed component (FR) on an intermediate rotating component (15) and a toothed component (TC) on the rotating output component (4) for a reverse ratio.

15. Device according to claim 9, characterized in that the at least one counter gear comprises a second counter gear (E2, E4) mounted on a rotating input component (1) between a toothed output component (4) and a toothed intermediate component (F6, FR) mounted on a second intermediate rotating component (15) holding at least one common toothed component (DC) engaging with a toothed input component (E6).

16. Device according to claim 9, characterized in that the at least one rotating input component comprises two rotating input components (1, 2) that can be alternatively and selectively coupled with a drive shaft (3), one of the rotating input components (2, 1) driving the counter gear (ST) held by the rotating output component (4), the other (1, 2) holding toothed input components (E1, E3, E2, E4) that define ratios that alternate with those defined via the intermediate toothed components (D2, D4, D1, D3).

17. Device according to claim 1, characterized in that the at least one rotating input component comprises two rotating input components (1, 2) that can be selectively engaged with the same engine, the shift from one gear ratio to a neighbouring gear ratio comprising an action of engaging at least one of the rotating input components (1, 2) and disengaging the other rotating input component.

18. Device according to claim 16, characterized in that the rotating input components (1, 2) are coaxial.

19. Device according to claim 16, characterized in that a rotating input component comprises only one toothed component (E5, E6) engaging with the at least one counter gear (ST).

20. Device according to claim 1, characterized in that it comprises a single rotating output component (4).

21. Device according to claim 1, characterized in that it comprises:
two direct ratios each produced by direct engagement of a first toothed input component (E2, E4) with a toothed output component (S2, S4).
two first indirect ratios produced by a series of engagements passing through a first counter gear (ST) held by the rotating output component (4),
two second indirect ratios produced by a series of engagements passing through at least a second counter gear held by a rotating input component (E4,E2), and,
a ratio (E5-S5) produced by direct engagement between the first rotating input component (1) and the first counter gear (ST) coupled with the rotating output component (4).

22. Device according to claim 21, characterized in that it comprises an additional ratio (E7-S7) produced by direct engagement between a rotating input component (1) and the rotating output component (4), with the same coupler (C57) as the one used to couple the first counter gear (ST) with the output component (4).

23. Device according to claim 21, characterized in that it comprises two intermediate rotating components (5, 15) and in that it comprises a double coupler (C24) on the at least one rotating input component (1, 2), a double coupler (C57) on the rotating output component (4) and a double coupler (C6R, C13) on each of the intermediate rotating components (5,15).

24. Device according to claim 21, characterized in that it comprises two concentric input components (1, 2), one of them (2) engaging with the first intermediate rotating component (15) and holding the first two toothed components (E2, E4), the other engaging with the second counter gear (ST) and preferably engaging via another pair of sets of teeth (E7, S7) with the rotating output component (4).

25. Use of a device according to one of the previous claims for the gearbox of a vehicle with at least two powered axles.
